(19) United States
(12) Patent Application Publication
(10) Pub. No.: US 2026/0147409 A1
(43) Pub. Date: May 28, 2026

(54) SYSTEM AND METHOD FOR GAZE-DRIVEN COMPUTER CONTROL

(71) Applicant: MIRAMETRIX INC., Montreal (CA)

(72) Inventors: Jacob FISET, Montreal (CA); Mohamad KHARBOUTLY, Montreal (CA); Michel BOIVIN, Montral (QC); Martin GAMSBY, Montreal (QC)

(21) Appl. No.: 19/452,081

(22) Filed: Jan. 16, 2026

Related U.S. Application Data
(63) Continuation of application No. PCT/CA2024/050921, filed on Jul. 10, 2024.
(60) Provisional application No. 63/513,998, filed on Jul. 17, 2023.

(51) Int. Cl. G06F 3/01

(52) U.S. Cl. CPC G06F 3/013; G06F 3/017

(57) ABSTRACT

Systems and methods for enabling a user to interact with a graphical user interface using gaze information of the user, comprising: at an electronic device in communication with a display component and a gaze tracking device: detecting an initiation request to initiate gaze based navigation, the initiation request being an input from the user; in response to the request to initiate gaze based navigation from the user, displaying, via the display component, an animation of a plurality of selectable elements; determining by the gaze tracking device, after obtaining gaze information of the user, that the user's gaze is associated with a desired one of the selectable elements; informing, via the animation, the user of the association with the desired selectable element; detecting a termination request to end the gaze based navigation, the termination request being a mechanical input from the user; and in response to the termination request, displaying via the display component, a user interface associated with the desired selectable element.

### CROSS-REFERENCE TO RELATED APPLICATIONS

This application is a continuation of pending International Patent Application No. PCT/CA2024/050921, filed on Jul. 10, 2024, which claims the benefit of U.S. Provisional Application No. 63/513,998, filed on Jul. 17, 2023, each of which are hereby incorporated by reference herein in their entireties.

### TECHNICAL FIELD

The following relates generally to systems and methods for gaze-driven interaction with computing devices, particularly gaze-driven control of user interfaces shown on computing device displays.

### BACKGROUND

Gaze-tracking systems provide a powerful tool for monitoring and/or enabling human-computer interactions. For example, points of interest to the user on a computer display may be determined by tracking the gaze of the user, such as by leveraging the built-in camera on a portable computing device.

Computers have traditionally incorporated user interfaces that utilize input devices, such as a mouse and keyboard. As computers have become more portable, however, the use of such input devices becomes less practical for users. One way to provide easier portable computer usage has been with touch screens. However, users may experience difficulties navigating the increasing amount of online content and computer applications.

Attempts have been made to add gaze-tracking as an input modality to facilitate user interactions with computing devices. However, many existing solutions enabling gaze-driven computer control involve time consuming gaze calibration processes and/or have poor selection accuracy.

It is desirable to continue ameliorating systems and methods for gaze-driven control of computer user interfaces.

### SUMMARY

In one aspect, provided is a method for enabling a user to interact with a graphical user interface using gaze information of the user, the method comprising: at an electronic device in communication with a display component and a gaze tracking device: detecting an initiation request to initiate gaze based navigation, the initiation request being an input from the user; in response to the request to initiate gaze based navigation from the user, displaying, via the display component, an animation of a plurality of selectable elements; determining by the gaze tracking device, after obtaining gaze information of the user, that the user's gaze is associated with a desired one of the selectable elements; informing, via the animation, the user of the association with the desired selectable element; detecting a termination request to end the gaze based navigation, the termination request being another input from the user; and in response to the termination request, displaying via the display component, a user interface associated with the desired selectable element.

In an implementation, the method further comprises implicitly calibrating the user's gaze to the gaze tracking device during the animation such that the user does not need to perform an explicit calibration.

In another implementation, implicitly calibrating the user's gaze to the gaze tracking device comprises: displaying, via the display component, a passive calibration animation, wherein the passive calibration animation includes one or more of: the selectable elements traveling in a predefined path to attract the gaze of the user, and adjusting the appearance of one or more of the selectable elements to attract the gaze of the user.

In yet another implementation, the animation displays the plurality of selectable elements in at least: a first configuration; a second configuration in which the selectable elements are more clustered than in the first configuration; and a third configuration in which the selectable elements are more scattered than in the first configuration, wherein the selectable elements are visible to the user during transition between configurations.

In yet another implementation, the user is informed of the desired selectable element by the desired selectable elements being highlighted and/or enlarged.

In yet another implementation, the method further comprises prompting the user to perform an explicit calibration if the implicit calibration is unsuccessful.

In yet another implementation, the selectable elements are arranged in a 2×3 array.

In yet another implementation, the selectable elements are arranged in a 3×4 array.

In yet another implementation, the selectable elements are arranged in a circular pattern.

In yet another implementation, the desired selectable element is determined at least in part by head posture and/or hand gesture information of the user.

In yet another implementation, selecting the desired selectable element generates another animation of a plurality of additional selectable elements, the input from the user is a mechanical input.

In yet another implementation, the mechanical input is the pressing of a button by the user.

In yet another implementation, the button is a key on a keyboard in communication with the electronic device.

In yet another implementation, the input is a hand gesture.

In yet another implementation, the input is the voice of the user.

In another aspect, provided is an electronic device, comprising: one or more processors; memory; and one or more programs, wherein the one or more programs are stored in the memory and configured to be executed by the one or more processors, the one or more programs including instructions for carrying out any one of the aforementioned methods.

In yet another aspect, provided is a non-transitory computer readable storage medium storing one or more programs, the one or more programs comprising instructions, which when executed by one or more processors of an electronic device, cause the electronic device to carry out any one of the aforementioned methods.

### BRIEF DESCRIPTION OF THE DRAWINGS

Embodiments will now be described with reference to the appended drawings wherein:

FIG. 1 is a schematic illustration of a system for gaze-driven navigation of content on a display of a computing device by way of a gaze-driven user control interface.

FIG. 2 is a block diagram of an example embodiment of the gaze tracking system in FIG. 1.

FIG. 3 is a flow chart illustrating a method for navigating computer content on a display using the gaze-driven user control interface.

FIG. 4A is a schematic illustration of a screen shot of a user interface (UI) animation of UI elements in a first configuration, one of the UI elements to be gaze-selected by the user, the screenshot being at a first time following a user's request for gaze interaction.

FIG. 4B is a schematic illustration of a screenshot of the UI animation of FIG. 4A, the screenshot being at a second time, after the first time, the UI elements being in a second configuration that is expanded relative to the first configuration.

FIG. 4C is a schematic illustration of a screenshot of the UI animation of FIGS. 4A-B, the screenshot being at a third time, after the second time, the UI elements being in a third configuration that is expanded relative to the second configuration.

FIG. 5A is a schematic illustration of a screen shot of a user interface (UI) animation of UI elements in a first configuration, one of the UI elements to be gaze-selected by the user, the screenshot being at a first time following a user's request for gaze interaction.

FIG. 5B is a schematic illustration of a screenshot of the UI animation of FIG. 5A, the screenshot being at a second time, after the first time, the UI elements being in a second configuration that is expanded relative to the first configuration.

FIG. 5C is a schematic illustration of a screenshot of the UI animation of FIGS. 5A-B, the screenshot being at a third time, after the second time, the UI elements being in a third configuration that is expanded relative to the second configuration.

FIG. 5D is a schematic illustration of a screenshot of the UI animation of FIGS. 5A-C, the screenshot being at a fourth time, after the third time, wherein additional UI elements are presented to the user at a corner of the display.

FIG. 5E is a schematic illustration of a screenshot of the UI animation of FIGS. 5A-D, the screenshot being at a fifth time, after the fourth time, wherein the additional UI elements are in a configuration that is expanded relative to the configuration in FIG. 5D.

FIG. 5F is a schematic illustration of a screenshot of the UI animation of FIGS. 5A-E, the screenshot being at a sixth time, after the fifth time, wherein the additional UI elements are in a configuration that is expanded relative to the configuration in FIG. 5E.

FIG. 6 illustrates a flow chart of a method for navigating content on a computer display using gaze information of the user.

FIG. 7A is a schematic illustration of a screen shot of a user interface (UI) animation of UI elements in a first configuration, one of the UI elements to be gaze-selected by the user, the screenshot being at a first time following a user's request for gaze interaction.

FIG. 7B is a schematic illustration of a screenshot of the UI animation of FIG. 7A, the screenshot being at a second time, after the first time, the UI elements being in a second configuration that is contracted relative to the first configuration.

FIG. 7C is a schematic illustration of a screenshot of the UI animation of FIGS. 7A-B, the screenshot being at a third time, after the second time, the UI elements being in a third configuration that is expanded relative to the second configuration.

FIG. 7D is a schematic illustration of a screenshot of the UI animation of FIGS. 6A-C, the screenshot being at a fourth time, after the third time, the UI elements being in a fourth configuration that is expanded relative to the first and third configurations.

FIG. 8 is a schematic illustration of a screenshot of a UI animation including example UI elements.

FIGS. 9A-9C are schematic illustrations of screenshots of a UI animation showing UI elements in a 2×3 arrangement, but including icons indicating selection modalities of gaze, head position, and gesture, respectively.

FIGS. 10A-10B show a flow chart (spread across the two figures) illustrating a method for navigating content on a display using the gaze-driven user control interface, with secondary and tertiary user input options also included.

FIGS. 11A-11B are a schematic illustration of another embodiment of a configuration of UI elements, wherein the UI elements are arranged in a circle.

### DETAILED DESCRIPTION

Provided herein are systems and methods for gaze-driven interaction with computing devices, particularly gaze-driven control of content shown on computing device displays. The user may initiate interaction with a gaze-driven user control interface as desired to select from several user interface (“UI”) elements representing, e.g., frequently used applications, folders, and the like. In contrast to existing methods, many of which require time consuming explicit calibration or cumbersome user interfaces, frustrating users and decreasing practicality of a gaze-based input modality, the systems and methods described herein include passive calibration, described in greater detail below, ameliorating user experience. For example, upon activating a gaze based user interface according to the present disclosure, a user may be provided with a short-list of their most visited applications or folders for visual selection, presented in an aesthetically pleasing animation. The gaze-driven user control interface may be initiated by one or more physical inputs by the user (e.g., pressing and holding a button on the keyboard). These commands may be pre-determined (e.g., from the user's activity), defined by the user, or a combination thereof.

A gaze-driven user control interface according to the present disclosure may be implemented using computing devices including or having access to one or more cameras. In some embodiments, laptops having small screens (e.g., 14″ laptops) and suitable webcams (e.g., IR, RGB-IR and RGB) may be utilized. In some embodiments, laptops or computing devices with smaller or larger screens may be utilized. Such computing devices may leverage gaze tracking and gaze calibration to provide an intuitive gaze-enabled user interface (i.e., like a head-up display). The gaze-driven user control interface may implement, e.g., low-granularity gaze tracking and passive one-point gaze calibration. The required one-point gaze calibration may be conveniently obfuscated from the user by the design of the UI and associated animations, to provide a passive calibration with relatively little or no user guidance or onboarding needed. Additional UI animation elements may be used to reduce or minimize time-on-target of the user's gaze during the calibration phase, as will be discussed in greater detail below.

The gaze-driven user control interface may use reinforcement learning (RL) as part of the UI design to improve gaze accuracy, by creating a history of most accessed UI elements for a specific user and presenting those elements at different locations each time the user accesses the user interface. The gaze-driven user control interface may include secondary and/or tertiary fallback input modalities, should the user's gaze not be registered (due to, e.g., low accuracy, obstructions). In some embodiments, 3D head pose may be the secondary input modality. In some embodiments, hand tracking/pointing may be the tertiary input modality. In other embodiments, the gaze-driven user control interface may use gaze tracking as the primary input modality, with head pose and/or gestures as the secondary input modality, with tertiary input modality defaulting to using the keyboard and/or mouse.

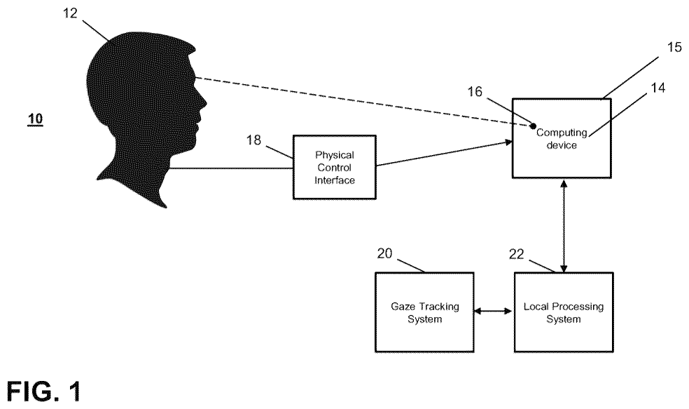

FIG. 1 illustrates a system 10 for gaze-driven navigation of content on a display 14 of a computing device 15. The system 10 comprises a physical control interface 18 such as, for example, a keyboard and/or mouse used by a user 12 to operate the computing device 15. The physical control interface 18 may be integral with the computing device 15, which may be, for example, a laptop computer. In other embodiments, the physical control interface 18 may include, for example, a wired or wireless keyboard, mouse, and/or suitable keyboard and mouse alternatives.

In the example shown in FIG. 1, the subject 12, when viewing the display 14 has a direction of gaze, also known as a line of sight, which is the vector that is formed from the eye of the subject to a point on an object of interest on the display 14. The point of gaze (POG) 16 is the intersection point of the line of sight with the object of interest. The object of interest in this example corresponds to a virtual object displayed on the display 14. The movement of the eyes can be classified into a number of different behaviors, however of most interest when tracking the POG 16, are typically fixations and saccades. A fixation is the relatively stable positioning of the eye, which occurs when the user is observing something of interest. A saccade is a large jump in eye position which occurs when the eye reorients itself to look towards a new object. Fixation filtering is a technique which can be used to analyze recorded gaze data and detects fixations and saccades. The movement of the subject's eyes and gaze information, POG 16 and other gaze-related data may be tracked by a gaze tracking system 20.

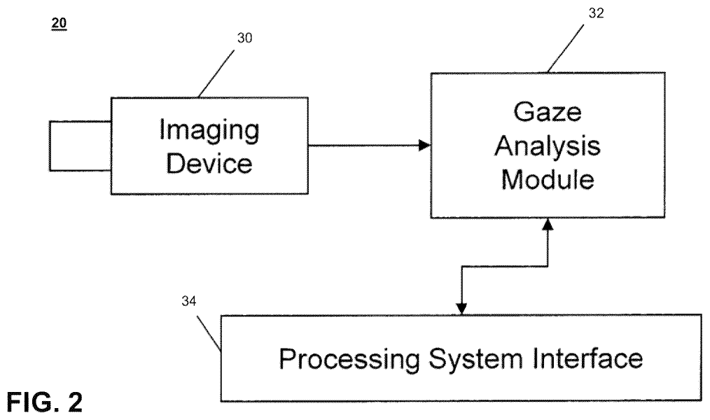

The gaze tracking system 20 may capture eye gaze information associated with the subject/user 12. The gaze tracking system 20 may implement more than one camera. The eye gaze information may be provided by the gaze tracking system 20 to a local processing system 22 to collect eye gaze data for further processing, e.g., to perform local processing and/or analysis if applicable, or to provide the eye gaze information to a remote data collection and analysis system (not shown). It can be appreciated that the local processing system 22 may also be remote to the gaze tracking system 20 and computing device 15. Data collection and analysis operations may be performed by the gaze tracking system, which may interact with the local processing system 22 via a processing system interface 34. The configurations shown in FIGS. 1 and 2 are illustrative only and may be modified suitably depending on, e.g., the end application or electronic devices available, as would be apparent to those skilled in the art.

The local processing system 22, in the example shown in FIG. 1, may be a separate computer, or a computer or processor integrated with the display 14. The gaze data being collected and processed may include, for example, where the user is looking on the display 14 for both the left and right eyes, the position of the subject's head and eyes with respect to the display 14, the dilation of the subject's pupils, and other parameters of interest. The local processing system 22 may use the eye gaze data for navigating menus on the display 14, as will be described in greater detail below. In some embodiments, the local processing system 22 is used to control the content on the display 14 and may provide directed content based on the subject's 12 gaze pattern. The terms “implicit” and “passive” are used herein interchangeably and refer to a passive calibration process carried out by the gaze tracking and processing systems by analyzing the user's gaze while an animation of potentially desired UI elements is run on the display 14.

An example of a configuration for the gaze tracking system 20 is shown in FIG. 2. The gaze tracking system 20 in this example includes an imaging device 30 for tracking the motion of the eyes of the subject 12, a gaze analysis module 32 for performing eye-tracking using data acquired by the imaging device 30, and a processing system interface 34 for interfacing with, obtaining data from, and providing data to, the local processing system 22. The gaze tracking system 20 may incorporate various types of eye-tracking techniques and equipment. It can be appreciated that any commercially available or custom generated eye-tracking or gaze-tracking system, module or component may be used. An eye tracker is used to track the movement of the eye, the direction of gaze, and ultimately the POG 16 of the subject 12. A variety of techniques are available for tracking eye movements, such as measuring signals from the muscles around the eyes. A common technique uses the imaging device 30 to capture images of the user's 12 eyes and process the images to determine the gaze information.

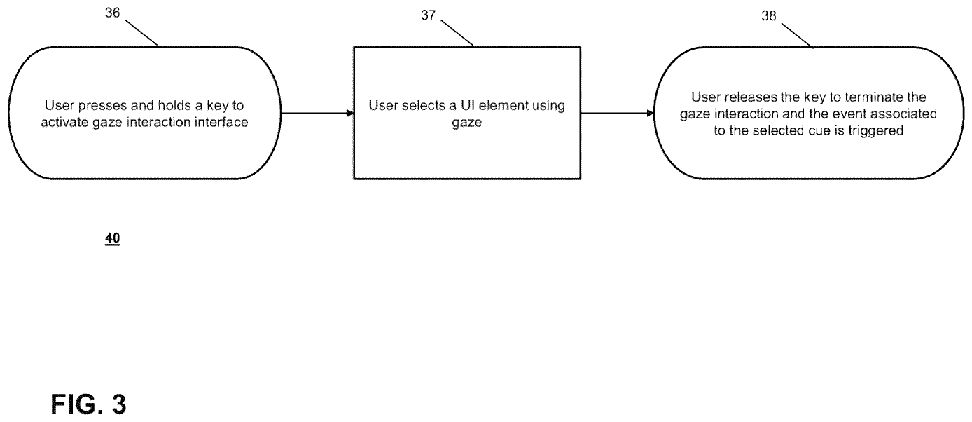

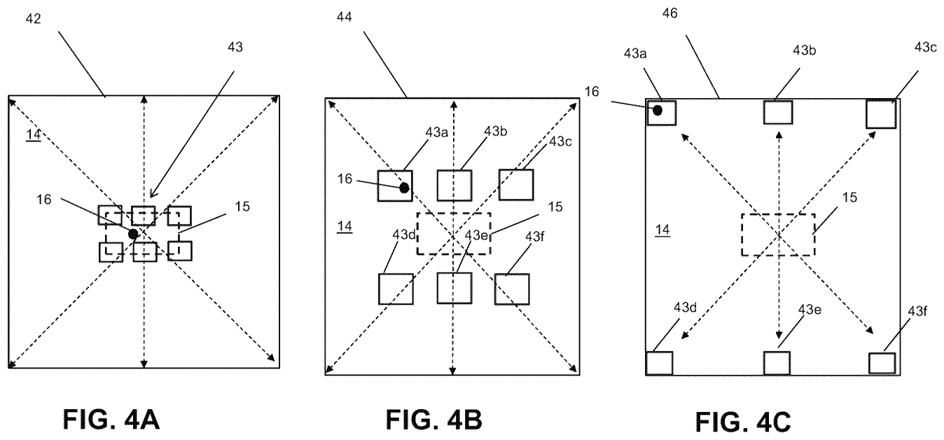

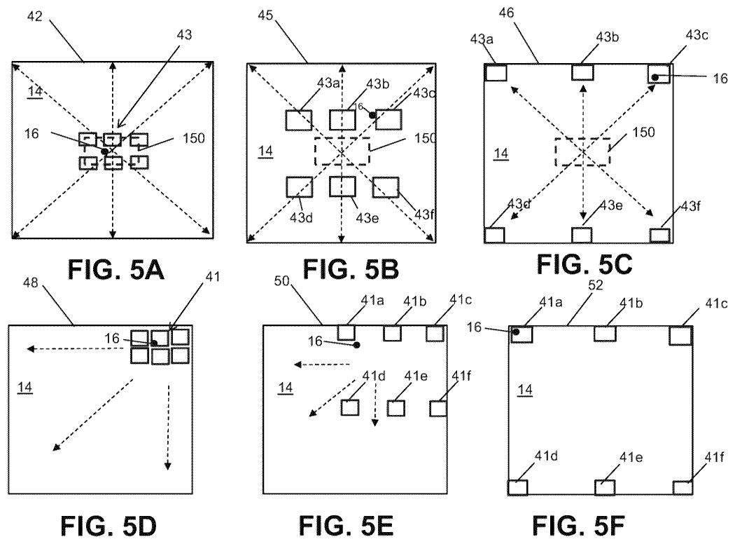

FIG. 3 is a flow chart illustrating a method 40 for navigating content shown on the display 14 using a gaze interaction user control interface, and FIGS. 4A-5C illustrate example embodiments of the display that is controllable by the user's 12 gaze. First, the user 12 presses and holds a key to activate a gaze interaction user control interface (36). Next, the user 12 selects a UI element using gaze (37), and at step 38 the user 12 releases the key to terminate the gaze interaction and trigger the event associated to the selected cue. For example, email, a web browser, a folder, or a shortcut may be triggered. Importantly, the user 12 may not be aware that their gaze is being implicitly calibrated during the process 40, providing an improved user experience as compared to existing solutions requiring explicit calibration.

FIG. 4A is a screenshot of a UI animation of UI elements 43a-43f (referred to collectively as UI elements 43) in a first configuration 42, one of the UI elements to be gaze-selected by the user, the screenshot being at a first time following a user's request for gaze interaction (step 36 in FIG. 3). The request for gaze interaction 36 may be initiated by the push of a button on a keyboard by the user 12, or by another predetermined physical input to a device configured to communicate with the computing device 15. Such physical input may include, but is not limited to, pressing a combination of buttons, swiping on a trackpad, scrolling on a mouse, a combination thereof, or other suitable physical inputs, depending on the device(s) available to the user 12. It will thus be understood that reference to a “button” or “key” herein may refer to such other physical inputs. Other input mechanisms/modalities may be implemented alone or in combination with the foregoing.

In an example embodiment, the POG 16 is positioned generally among the UI elements 43 grouped at the beginning of the screen shortly after the request for gaze interaction. In FIG. 4B, the UI animation screenshot shows the UI elements 43 in a second configuration 44, at a second time after the first time, wherein the elements 43 are expanded relative to the first configuration 42.

In this example embodiment, the POG 16 of the user 12 is shown to be following the UI element 43a. The gaze tracking system 20 is capable of accurately determining the POG 16 as a calibration, preferably an implicit calibration, has been performed, whereby the system 20 has confirmed that the user is looking at a target gaze calibration zone 15. The zone 15 is depicted as being rectangular in this example embodiment, but the zone 15 may alternatively be circular or have any other desired shape. Conditions for successful implicit calibration include, but are not limited to, the user's 12 face being oriented toward the zone 15, or at least not looking away from it, the user 12 being fixated (i.e., the user's gaze being relatively stationary), and the user's gaze generally falling within the zone 15. If the user's gaze is not falling within the zone 15, in some embodiments, the system 20 may cause the display to increase the size of the zone 15 to increase the chances of successfully completing implicit calibration (and avoiding explicit calibration, which may be considered detrimental to the user's experience). The size of the zone 15, may optionally be increased over time (within a pre-determined time period) until the user's gaze is relatively stationary and within the zone 15. If the pre-determined time period has elapsed and the user's gaze remains uncalibrated, optionally, the system 20 may nevertheless proceed with the animation and estimate POG 16 and the desired UI element. To increase the chance and/or speed of successful implicit calibrations, data from previous implicit calibrations for the user 12 may be used to inform the implicit calibration process. The system 20 may identify the user 12 by, for example, using facial recognition technology.

In some embodiments, the presentation of the UI elements may occur quickly, or may take more time. There may be a step to show the different options closely grouped near the calibration point/zone for a portion of time. This is so the user can see all options and choose their selection without having to look all around the screen. In some embodiments, when the UI elements are in their presentation position, a selection cannot be made. After a period of time the UI elements move to their selection position and at this time the user can select a desired element. For more experienced users shadows and dimmer versions of the selection items already at their position may be shown. If the gaze of the user moves outside the presentation area the presentation step may be cancelled, the points (i.e., UI elements) may be moved to their selection position. The opposite may also be implemented, i.e., have a very short presentation step but leave shadows or copies or the options in the center for the user to complete their selection. These copies may disappear once the gaze leaves the presentation area in the event that a region without selection in the center can be supported.

Continuing with respect to FIG. 4, FIG. 4C illustrates a UI animation screenshot of a third configuration 46, taken at a third time after the second time, wherein the UI elements 43 are evenly distributed at or near the border of the display 14. At this stage (step 37 in FIG. 3), the UI element 43a which is selected by the POG 16 may be highlighted (not shown), at which point the user 12 may confirm the selection (step 38 in FIG. 3) by releasing the button. After a certain length of time in which no UI elements 43 are selected, the onscreen menu may fade and disappear. In some embodiments, the physical input does not need to be maintained (i.e., button held) to sustain the gaze interaction. For example, the physical input may be released during selection of the desired UI element 43, and the same or a different physical input may be applied by the user 12 to confirm the selection and end the gaze interaction. FIGS. 5A-5C illustrate first, second, and third configurations (48, 50, 52) that are similar to those shown in FIGS. 4A-4C; however, the UI elements 43 are near the upper right corner of the display at the first time, i.e., at some time after the gaze interaction request by the user 12.

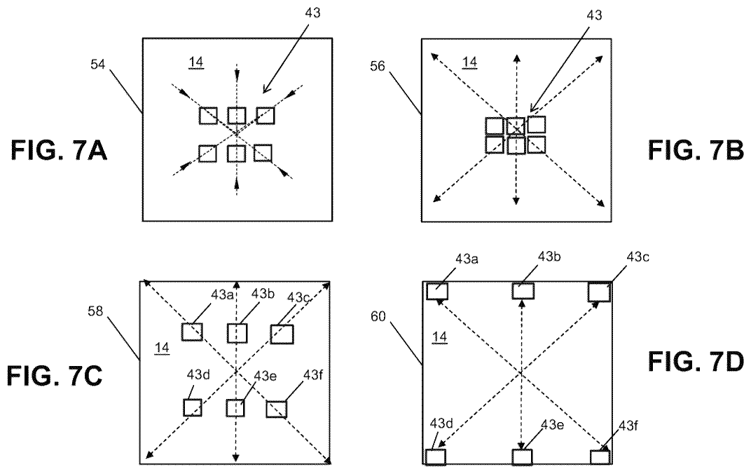

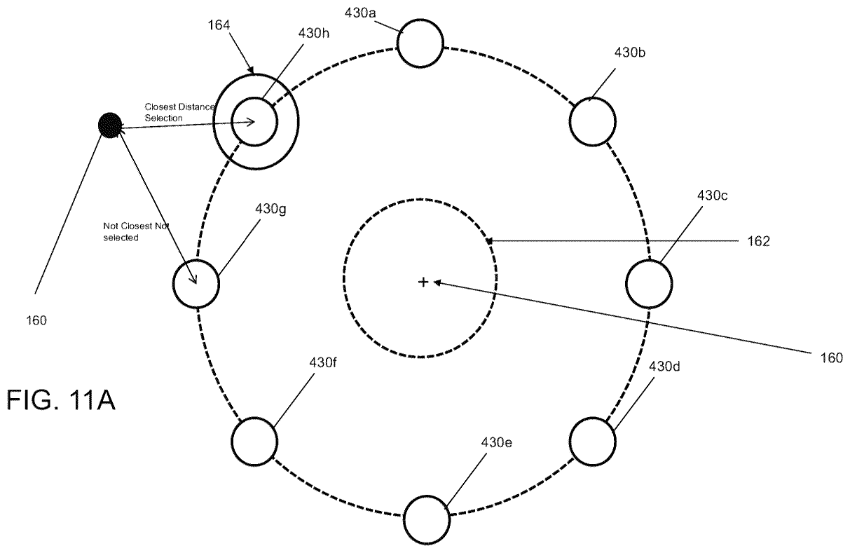

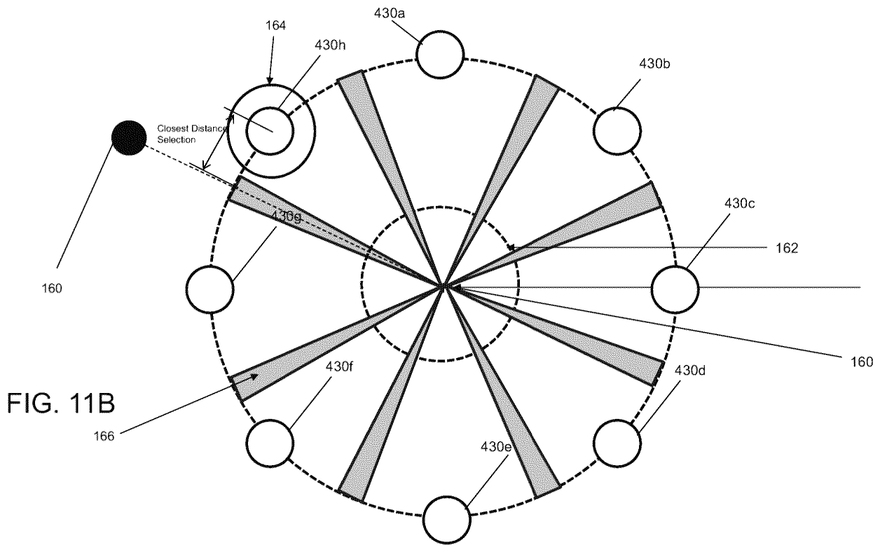

The UI elements 43 are represented generally, as squares. It will be understood that the UI elements 43 may be different icons or symbols such as, for example, an internet browser, file folder, screen brightness or volume up/down, and the like. The UI element(s) 43 may be defined by a geometric region on the screen. For example, a rectangle, circle (see FIG. 11), general polygon, or any shape. In the example embodiments illustrated in FIGS. 4 and 5, and in FIG. 7 discussed below, the UI elements 43 are arranged in a 2×3 array. The UI elements 43 may be configured to move through a series of configurations different than those depicted in FIGS. 4-7 throughout the gaze interaction (i.e., the time between when the user requests the gaze interaction and when the selected option is performed). In other embodiments, a different number of UI elements 43 may be used, e.g., 2, 4, 8, or more UI elements 43. In some embodiments, there may be an odd number of UI elements 43.

It will be understood that the specific configuration of the UI elements 43 on the screen may vary substantially. The positioning/configuration may be a function of the user's distance to the camera and screen the distance of the points to the camera the distance between the points with points further from the camera requiring to be spread apart more the manner in which the points are arranged and how many points may be selected then depends on the size of the screen and user distance to the screen. The system may present more or less points depending on these factors at runtime of the animation. The camera may be, from a functional standpoint, in the same 2D plane as the display. This distance between the display and the camera may be known to the processing system by direct means, such as firmware, or indirect means, i.e., inferred from the hardware configuration parameters (e.g., display dimensions, camera position with respect to the display, etc.).

To determine if a UI element 43 is being targeted, in some embodiments, the POG 16 on the display 14 can be determined, and the UI element 43 closest to the POG 16 will be identified as the desired UI element. While UI elements may be shown with a specific size to the viewer, the actual target size may be slightly larger to allow for inaccuracies in the gaze tracking system. The UI elements 43 may be made semitransparent to allow media content to continue to play behind the UI elements.

FIGS. 5A-5F are schematic illustrations of screen shots of a user interface (UI) animation of UI elements enabling the user 12 to select a desired UI element with their gaze. FIGS. 5A-5C are similar to FIGS. 4A-C described above. FIG. 5A shows the configuration 42 of the UI elements 43 at a time after the user 12 requests a gaze interaction, such as by providing a physical input as described above. Once the system 20 has confirmed that the user is looking at a target gaze calibration zone 150, the animation may proceed such that the UI elements 43 move away from one another to the configuration 46 shown in FIG. 5C, with the configuration 45 in FIG. 5B showing the intermediate configuration 45. The POG 16 of the user 12 is shown following the desired UI element 43c. The desired UI element 43c may then be highlighted, and when the user 12 confirms the system's 20 of the desired element 43c, the animation may proceed to the configurations 48, 50 and 52 shown in FIGS. 5D-5F. In this example embodiment, the UI element 43c leads to the generation of another set of UI elements 41 (i.e., a sub-menu). The use of sub-menus may enable the user 12 to access a greater number of UI elements than the number of UI elements that may be viewed at one time as constrained by the conditions of accurate implicit calibration discussed herein. The additional UI elements 41 may then separate from one another in the direction shown by the arrows in FIGS. 5D-E. As shown, the user's POG 16 is determined by the system to be following a subsequent desired UI element 41a, and the user may confirm the selection when the additional UI elements are in configuration 52 (FIG. 5F) by, e.g., releasing a key that was being held throughout the animation, pressing another key, or by some other physical input.

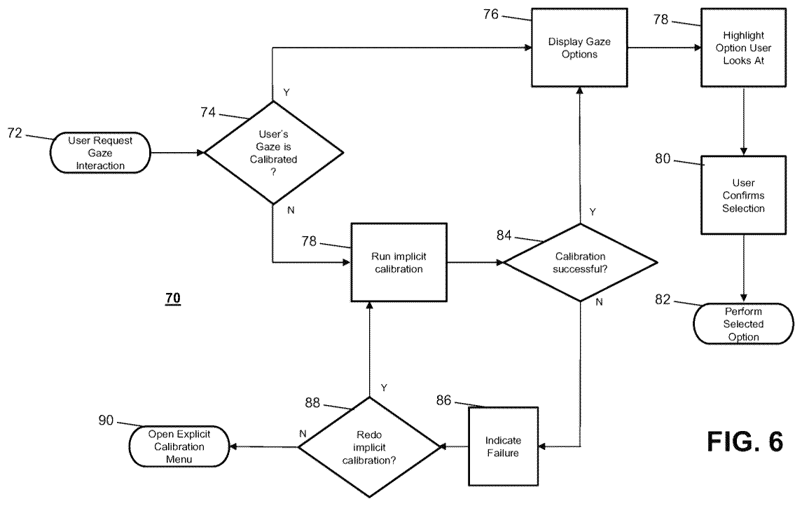

FIG. 6 is a flow chart illustrating a method 70 for navigating content on a display using a gaze interaction user control interface. The user 12 requests a gaze interaction at step 72, such as by providing a physical input as described above. Next, at step 74, it is determined whether the user's 12 gaze is calibrated. If yes, the gaze options are displayed (step 76), which may involve presenting a group of UI elements 43 for selection by the user 12 (see, e.g., FIGS. 4-5). The UI element 43a upon or near which the POG 16 falls for a pre-determined period of is then highlighted (step 78). Next, at step 80 the user 12 may confirm the selection by, for example, releasing the physical input or applying the same or a different physical input. The function associated with the UI element 43a is then triggered (step 82), and the UI animation for gaze interaction is terminated. If, at step 74, it is determined that the user's 12 gaze 74 is not calibrated, the gaze tracking system 20 may run an implicit calibration (step 78). If the calibration is successful (step 84), the method returns to step 76 and gaze options may be displayed. Otherwise, failure is indicated (86) and, at step 88, it is determined whether to redo implicit calibration. In some embodiments, the gaze analysis module 32 may be configured to permit implicit calibration to be redone a pre-determined number of times. If it is determined that implicit calibration is not to be redone, the method moves to step 90 and an explicit calibration may be conducted, which may involve providing the user 12 with prompts to walk them through a calibration. In some embodiments, the user 12 may be permitted to conduct an explicit calibration at any point, e.g., when using their computing device 15 for the first time.

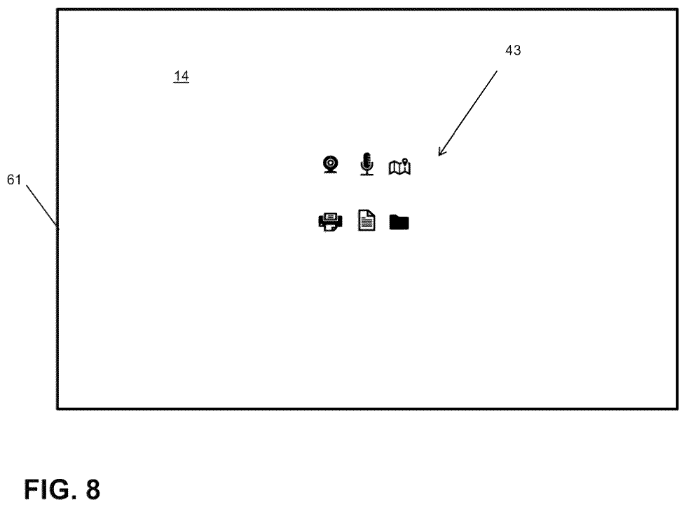

FIG. 7A-7D are screenshots of another embodiment a UI animation of UI elements 43 in first, second, third, and fourth configurations (54,56,58,60), ordered chronologically. As shown, there is a contraction of the relative positions of the elements 43 between configurations 54 and 56. Such contraction may focus the user's 12 gaze within the target zone (not shown) for a pre-determined amount of time, while the implicit, passive one-point calibration is performed in the background. Implementation of such contraction animation may be the default option, or may be performed after, for example, one or more unsuccessful implicit calibrations using starting configurations including UI elements more closely clustered together (e.g., 42 or 48). Another way to improve the calibration/gaze accuracy may be to bias the position of the UI elements toward the camera placement. FIG. 8 is a screenshot of another embodiment a UI animation of example UI elements 43, i.e., webcam, microphone, map, printer, document, folder.

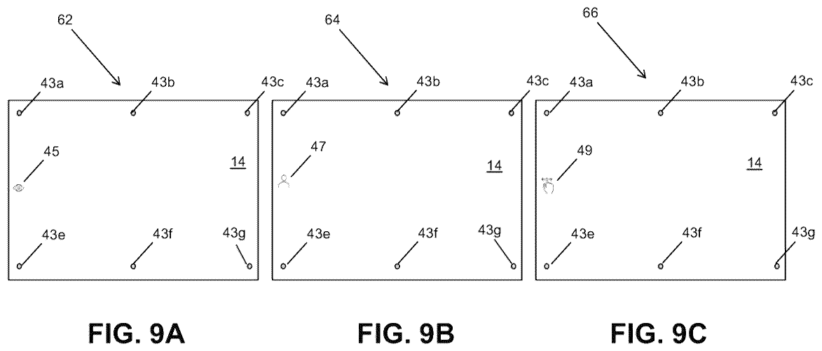

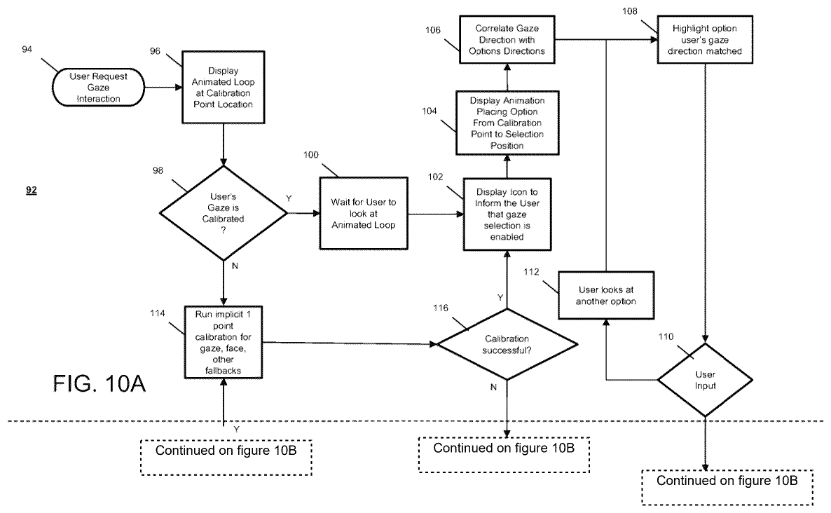

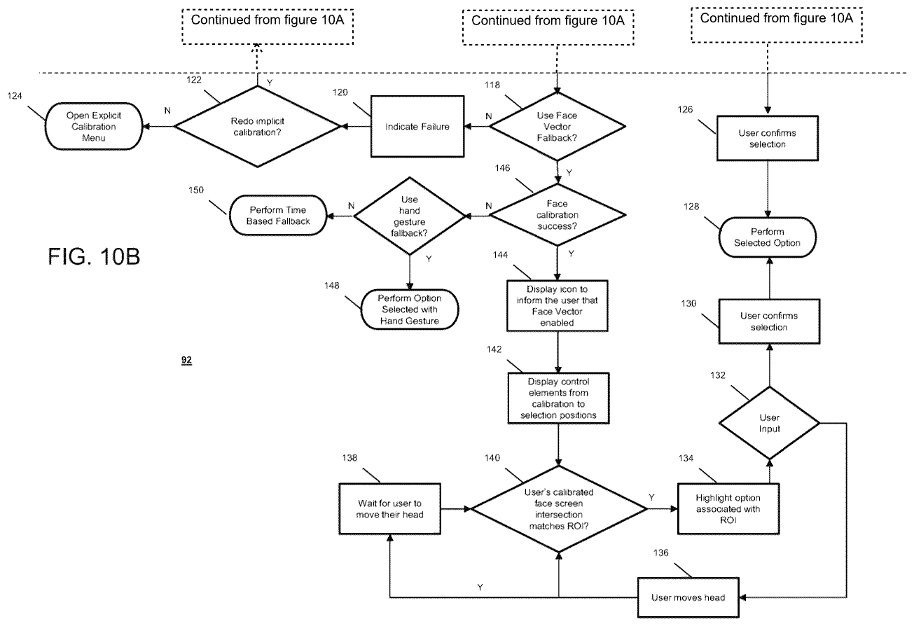

FIGS. 9A-9C are screenshots of another embodiment a UI animation of UI elements 43 in first, second, and third configurations (62,64,66). The configurations 62,64, and 66 include small overlays/icons 45, 47, and 49, respectively, to indicate to the user the currently active/available input modality, in the event that one or more input modalities are available as discussed in greater detail with respect to FIG. 10. Icon 45 indicates that the gaze tracking input modality is active, icon 47 indicates that the head pose input modality is active, and icon 49 indicates that the hand gesture input modality is active.

FIGS. 10A-10B are a flow chart illustrating a method 92 for navigating computer content using one or more of gaze, head position, and hand gesture detection. In this example embodiment, head position detection and hand gesture detection are fallback modalities. The user 12 requests a gaze interaction at step 94. Next, at step 96, UI elements 43 may be displayed at a calibration point location, shown in an animated loop which may cause the elements 43 to move across the display 14 smoothly from the user's perspective 12, (e.g., appear near the bottom of the display and move smoothly up into a cluster in the center of the display 14 as shown in FIG. 4). If the user's gaze is calibrated (step 98), the system waits for the user to look at the UI elements 43 at step 100. The method then moves to step 102, whereby an icon is displayed (e.g., icon 45) to inform the user 12 that gaze interaction is underway. At step 104, the clustered UI elements 43 may move from their calibration points/configuration to their selection positions/configuration, such as evenly distributed near the edge of the display. The system may then correlate the gaze information with the path taken by each of the UI elements (step 106), thereby estimating the desired UI element 43 and highlighting it at step 108. At step 110, the user 112 may then either confirm the selection (126) which would cause the action associated with the desired element to be performed, or the user may look at another UI element 112 (e.g., if the user 112 does not release the button/terminate the interaction), and the method may return to step 108.

If, at step 98, the user's 112 gaze is not calibrated, the method moves to step 114, in which an implicit calibration may be carried out. If the calibration is successful (116), the method may move to step 102 discussed above. Otherwise, it is determined whether it is desired to use a face vector modality (i.e., head position) at step 118. If not, failure is indicated (step 120), and if implicit calibration is to be repeated, the method returns to step 114. Otherwise, the explicit calibration menu may be opened (step 124). If it is desirable to use the face vector fallback, the method may move the step 146, wherein the system 20 obtains necessary facial data for calibration (146). If calibration is not successful, it is determined whether a hand gesture input modality is desired. If no, a time based fallback (150) may be used, i.e., whereby individual UI elements are successively highlighted, and the user provides a confirmatory input when the desired UI element is highlighted. Otherwise, a hand gesture based selection may be implemented (148). If facial calibration 146 is successful, the method moves through steps 144 and 142, then, at step 140, it is determined whether the user's facial orientation matches a given region of interest (e.g., a zone around each UI element shown), and if yes, the option associated with the region of interest is highlighted (134). The user may then be prompted to provide an input as to whether the highlighted UI element is highlighted (132). If yes, the user may confirm the selection 130 (such as by pressing or releasing a key), and the process associated with the UI element of interest may be performed (128). If the user's facial orientation does not match/correspond to a region of interest, the system may wait for the user 12 to move their head (138), at which point the method returns to step 140. Similarly, if at step 132 the user indicates that the desired UI element is not highlighted, the method may move to step 136, wherein the user may move their head, and the method returns to step 140.

FIG. 11A is a schematic illustration of UI elements 430a-430h (430 collectively) on a display (not shown). In this example embodiment, the UI elements are in a circular configuration, and a method for determining the UI element of interest is shown. The distance between a POG 160 of the user 12 and two or more UI elements 430 may be compared and, and the smallest distance between the POG 160 and UI elements (430g, 430h) will inform the estimated desired UI element (in this case, 430h). In other embodiments, other methods for estimating the UI element may be used, e.g., implementing zones. Selection feedback 164 (e.g., enlargement, highlighting, shimmering, and the like, of the UI element 430h) may be provided to notify the user of the estimated UI element (of interest. In some embodiments, prior to estimating the UI element of interest, system 20 may carry out a passive calibration in a manner similar to that discussed above. In the example embodiment shown in FIG. 11A, a so-called “dead zone” 162 is provided on the display. In some embodiments, if the user's gaze is determined to be in this region, the process of selection of a desired UI element may not be initiated, so as to enable, for example, implicit calibration. FIG. 11B is similar to FIG. 11A, but includes buffer zones 166 to account for variations in the user's gaze, i.e., “noisy” data.

The methods described herein may be embodied in sets of executable machine code stored in a variety of formats such as object code or source code. The executable machine code or portions of the code may be integrated with the code of other programs, implemented as subroutines, plug-ins, add-ons, software agents, by external program calls, in firmware or by other techniques as known in the art.

Any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method for enabling a user to interact with a graphical user interface using gaze information of the user, the method comprising:
at an electronic device in communication with a display component and a gaze tracking device:
detecting an initiation request to initiate gaze based navigation, the initiation request being an input from the user;
in response to the request to initiate gaze based navigation from the user, displaying, via the display component, an animation of a plurality of selectable elements;
determining by the gaze tracking device, after obtaining gaze information of the user, that the user's gaze is associated with a desired one of the selectable elements;
informing, via the animation, the user of the association with the desired selectable element;
detecting a termination request to end the gaze based navigation, the termination request being another input from the user; and
in response to the termination request, displaying via the display component, a user interface associated with the desired selectable element.

2. The method of claim 1, wherein the method further comprises implicitly calibrating the user's gaze to the gaze tracking device during the animation such that the user does not need to perform an explicit calibration.

3. The method of claim 2, wherein implicitly calibrating the user's gaze to the gaze tracking device comprises:
displaying, via the display component, a passive calibration animation, wherein the passive calibration animation comprises includes one or more of: the selectable elements traveling in a predefined path to attract the gaze of the user, and adjusting the appearance of one or more of the selectable elements to attract the gaze of the user.

4. The method of claim 1, wherein the animation displays the plurality of selectable elements in at least:
a first configuration;
a second configuration in which the selectable elements are more clustered than in the first configuration; and
a third configuration in which the selectable elements are more scattered than in the first configuration, wherein the selectable elements are visible to the user during transition between configurations.

5. The method of claim 1, wherein the user is informed of the desired selectable element by the desired selectable elements being highlighted and/or enlarged.

6. The method of claim 1, wherein the method further comprises prompting the user to perform an explicit calibration if the implicit calibration is unsuccessful.

7. The method of claim 1, wherein the selectable elements are arranged in a 2×3 array.

8. The method of claim 1, wherein the selectable elements are arranged in a 3×4 array.

9. The method of claim 1, wherein the selectable elements are arranged in a circular pattern.

10. The method of claim 1, wherein the desired selectable element is determined at least in part by head posture and/or hand gesture information of the user.

11. The method of claim 1, wherein selecting the desired selectable element generates another animation of a plurality of additional selectable elements.

12. The method of claim 1, wherein the input from the user is a mechanical input.

13. The method of claim 12, wherein the mechanical input is the pressing of a button by the user.

14. The method of claim 13, wherein the button is a key on a keyboard in communication with the electronic device.

15. The method of claim 1, wherein the input is a hand gesture.

16. The method of claim 1, wherein the input is the voice of the user.

17. An electronic device, comprising:
one or more processors;
memory; and
one or more programs, wherein the one or more programs are stored in the memory and configured to be executed by the one or more processors, the one or more programs including instructions for carrying out the method of claim 1.

18. A non-transitory computer readable storage medium storing one or more programs, the one or more programs comprising instructions, which when executed by one or more processors of an electronic device, cause the electronic device to carry out the method of claim 1.
